(19) United States
(12) Patent Application Publication
(10) Pub. No.: US 2012/0186551 A1
(43) Pub. Date: Jul. 26, 2012

(54) Device for Starting an Internal Combustion Engine

(76) Inventors: Simon Rentschler, Changsha (CN); Harald Schueler, Backnang (DE); Sven Hartmann, Stuttgart (DE); Juergen Gross, Stuttgart (DE); Karl-Otto Schmidt, Keltern (DE)

(21) Appl. No.: 13/388,957

(22) PCT Filed: Jun. 11, 2010
(86) PCT No.: PCT/EP2010/058203

§ 371 Date: Apr. 13, 2012

(30) Foreign Application Priority Data
Aug. 6, 2009 (DE) 102009028294.7

(51) Int. Cl. F02N 11/00

(52) U.S. Cl. 123/179.3; 123/179.1

(57) ABSTRACT

A device for starting an internal combustion engine has a meshing module which is provided for meshing a drive pinion, a starter motor, a switching module via which a starter current is suppliable to the starter motor, and a control unit which is provided for energizing the meshing module and the switching module.

### BACKGROUND OF THE INVENTION

1. Field of the Invention

The present invention relates to a device for starting an internal combustion engine.

2. Description of the Related Art

For starting internal combustion engines, drives are used which are supplied by an energy source that is independent from the fuel supply. As a rule, direct current motors are used whose drive pinion initially meshes with an annular gear of the internal combustion engine in order to subsequently drive the internal combustion engine. After termination of the starting operation, the drive pinion disengages from the annular gear of the internal combustion engine. A shared relay is used for the meshing operation and switching the main current through for driving the direct current motor. An associated schematic wiring diagram is illustrated in FIG. 1, which shows a relay 1 connected to a terminal 50, a switch 2, a control unit 5, terminal 30 of the motor vehicle, and a starter motor M. Control unit 5 has a driver TR0 which is acted upon by a switching signal S₀₀. When driver TR0 is switched through, relay 1 is connected to a positive operating voltage+via a control line SL0 and terminal 50. Relay 1 is then energized and closes switch 2. As the result of switch 2 closing, starter motor M is connected to terminal 30 of the motor vehicle, and is thus put into operation.

A starter device for starting an internal combustion engine is known from published European patent document EP 0 848 159 B1, having a starter motor which is connectable to a voltage source via a starter relay and which is engageable with the internal combustion engine for cranking the internal combustion engine. In addition, an electronic control unit is provided for energizing the starter relay and/or the starter motor. The electronic control unit controls semiconductor power output stages associated with the starter relay and/or the starter motor in such a way that, at least during start-stop operation of the internal combustion engine, the starter relay is in its meshing position in the stopped state of the internal combustion engine. For this starter device, the starter relay is energized after a start switch is activated, so that on the one hand a contact which connects the starter motor to a supply voltage is closed, and on the other hand, independently therefrom, the pinion of the starter motor meshes with an annular gear situated on a crankshaft of the internal combustion engine.

Published German patent application document DE 10 2009 000 125.5 describes a device for controlling an electromagnetic switching element, in particular a relay, in which the period of time that elapses between triggering of the energization and the energization, and also the period of time that elapses between triggering of the deenergization and the deenergization, is reduced. This type of relay may be used in conjunction with pinion/starter-based start-stop systems. For energizing this type of relay, three control lines are provided via which a control unit activates switching elements which, as a function of their switching position, allow or block a current flow through two independently energizable coils of the relay.

### BRIEF SUMMARY OF THE INVENTION

A device for starting an internal combustion engine according to the present invention has the advantage over the related art that an improvement in the start-stop operation of the internal combustion engine is achieved due to the separation of the meshing mechanics from the contact-making of the starter current. In particular, an internal combustion engine equipped with the device is able to respond quickly to a restart intent of the driver. Furthermore, little or no dip in starting voltage occurs in an internal combustion engine equipped with the device.

In addition, the device may be easily integrated into an existing mechanical design of internal combustion engines and transmissions. The components of the device may be flexibly mounted in a modular manner. The switches may be used with an additional series resistor, even for conventional systems, for reducing a dip in starting voltage.

A device according to the present invention results in lower overall costs compared to systems which electronically switch or regulate the starting current.

In addition, for a device according to the present invention, less meshing noise and less cranking noise occurs on account of smooth meshing and smooth cranking.

Furthermore, the service life of the starter device is prolonged due to the smooth meshing, smooth cranking, and peak current reduction.

The present invention is suitable for promoting increasing prevalence of motor vehicles having start-stop functionality, meets expanded system requirements compared to previous start-stop systems, and is associated with an expansion in the functions of the start-stop system. This includes ensuring the starting capability of the particular vehicle upon every start intent of the driver. This also includes the occurrence of little or no voltage dip during starting. These advantages are achieved in particular in that the main current for the starter motor is conducted, on the one hand via a series resistor, and on the other hand directly to the starter motor in a time-delayed manner. This is implemented in that the functionalities of a conventional starter relay are separated. According to the present invention, a meshing module for meshing the drive pinion and a switching module are provided for conducting the starter current on the one hand via a series resistor, and on the other hand directly to the starter motor in a time-delayed manner.

### BRIEF DESCRIPTION OF THE DRAWINGS

FIG. 1 shows a wiring diagram of a conventional device for starting an internal combustion engine.

FIG. 2 shows a wiring diagram for explaining the basic design of a device according to the present invention for starting an internal combustion engine.

FIG. 3 shows diagrams for illustrating the control of relays ES, KA, and KH shown in FIG. 2.

FIG. 4 shows one exemplary embodiment of a mechanical solenoid switch (ES).

FIG. 5 shows options for connecting the elements of switching module SM.

FIGS. 6, 7, and 8 show block diagrams of a device for starting an internal combustion engine with the aid of control units having various designs.

FIG. 9 shows time diagrams for illustrating the relay energization for an initial start of a vehicle.

FIG. 10 shows time diagrams for illustrating the relay energization for an automatic start carried out within the scope of the start-stop operation.

FIG. 11 shows a diagram for illustrating one example of the variation over time of the speed of the internal combustion engine, the speed of the starter motor, and the current of the starter motor during a start-stop operation.

FIG. 12 illustrates one example of a simplified system.

### DETAILED DESCRIPTION OF THE INVENTION

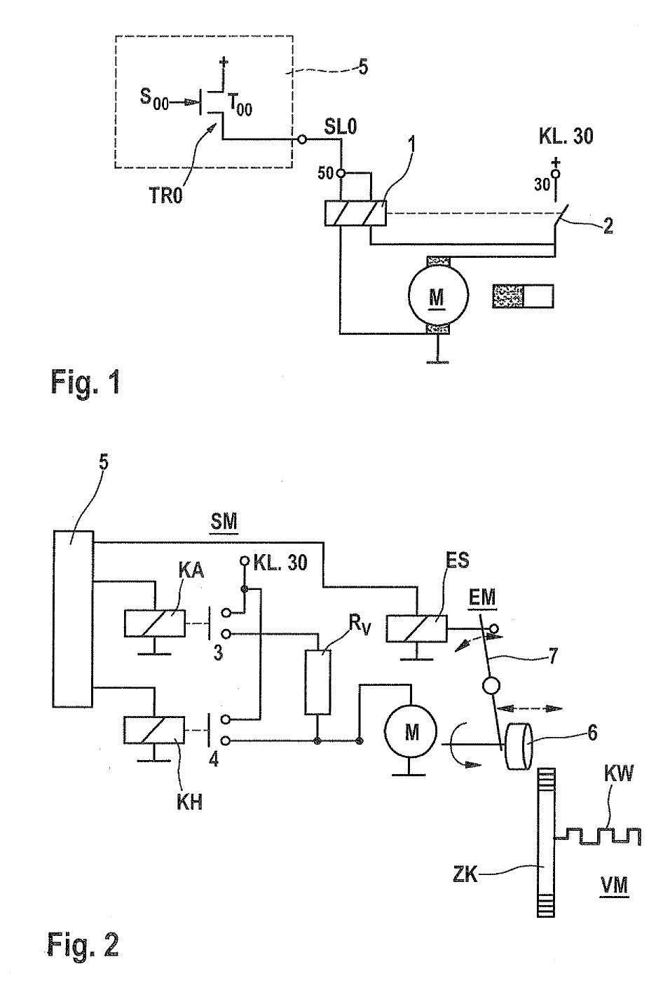

FIG. 2 shows a wiring diagram for explaining the basic design of a device according to the present invention for starting an internal combustion engine. This device has a starter motor M, a series resistor R_{V}, a meshing module EM, a switching module SM, and a control unit 5. Meshing module EM has a solenoid switch ES, an engaging shift lever 7, and a drive pinion 6. Meshing module EM is provided for meshing drive pinion 6 with an annular gear ZK of crankshaft KW of internal combustion engine VM. Switching module SM contains a starting current relay KA, a main current relay KH, a first switch 3, and a second switch 4. Switches 3 and 4 are designed as mechanical switches. Switching module SM and meshing module EM and relays ES, KA, and KH, are each energized by control unit 5. A first connector of switch 3 is connected to terminal 30 of the particular motor vehicle, to which the battery voltage of the motor vehicle is continuously applied. A further connector of switch 3 is connected to starter motor M via series resistor R_{V}. The control connector of switch 3 is connected to starting current relay KA. A first connector of switch 4 is likewise connected to terminal 30 of the motor vehicle. A further connector of switch 4 is directly connected to starter motor M. The control connector of switch 4 is connected to main current relay KH. Switching module SM is provided for switching the starter current, either via series resistor R_{V} or directly to starter motor M.

When the vehicle is started, solenoid switch ES is initially energized in order to mesh drive pinion 6 with annular gear ZK of crankshaft KW of internal combustion engine VM with the aid of engaging shift lever 7. First switch 3 is then brought into the closed state by energizing starting current relay KA, so that terminal 30 is connected to starter motor M via first switch 3 and series resistor R_{V}. Main current relay KH is then energized in a time-delayed manner, so that second switch 4 is brought into the closed state. Terminal 30 is thus connected directly to starter motor M via switch 4.

This separation of the functionalities of a conventional starter relay allows smooth meshing of the drive pinion of the starter motor with the annular gear of the crankshaft of the internal combustion engine, and also smooth and noiseless yet reliable cranking of the crankshaft of the internal combustion engine during every start intent of the driver. In addition, the cranking of the starter and the kick-in are independent from one another, which is advantageous for the meshing with the coasting engine.

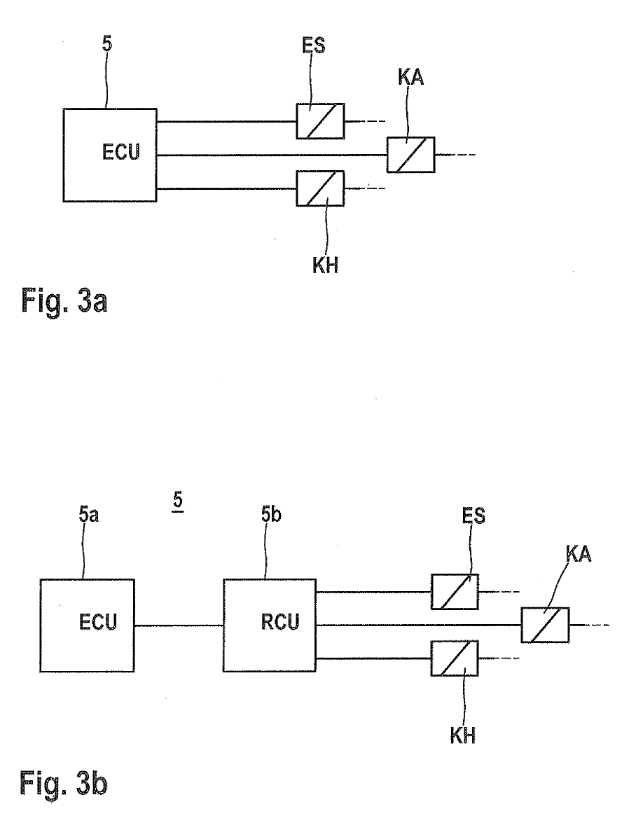

Control unit 5 is either the engine control unit of the particular motor vehicle or a separate control unit of the motor vehicle. This is illustrated in FIG. 3. FIG. 3a shows energization of relays ES, KA, and KH by engine control unit ECU of the motor vehicle, and FIG. 3b shows energization of these relays by a separate control unit RCU (relay control unit), which on its part is energized by engine control unit ECU of the motor vehicle. The number of lines required for the control depends on the type of relays used, i.e., the number of coils or windings of the relays. In one preferred design, a device is used for energizing each of the relays, as described in published German patent application document DE 10 2009 000 125.5 by the present applicant. This device has switching means and a coil, a magnetic force which acts on the electromagnetic switching element being exerted by energizing the coil, and the device having two independently energizable coils for allowing high accuracy and short delay times to be ensured during energization and deenergization of the electromagnetic switching element.

The individual components of the device illustrated in FIG. 2 are described in greater detail below.

Starter motor M, which is provided for meshing drive pinion 6 with the annular gear of the crankshaft of the internal combustion engine and for cranking the crankshaft, is implemented as a direct current machine.

Meshing module EM has a mechanical relay ES or, alternatively, an electric servomotor. The function of contact making of the starter current is not implemented by the meshing module.

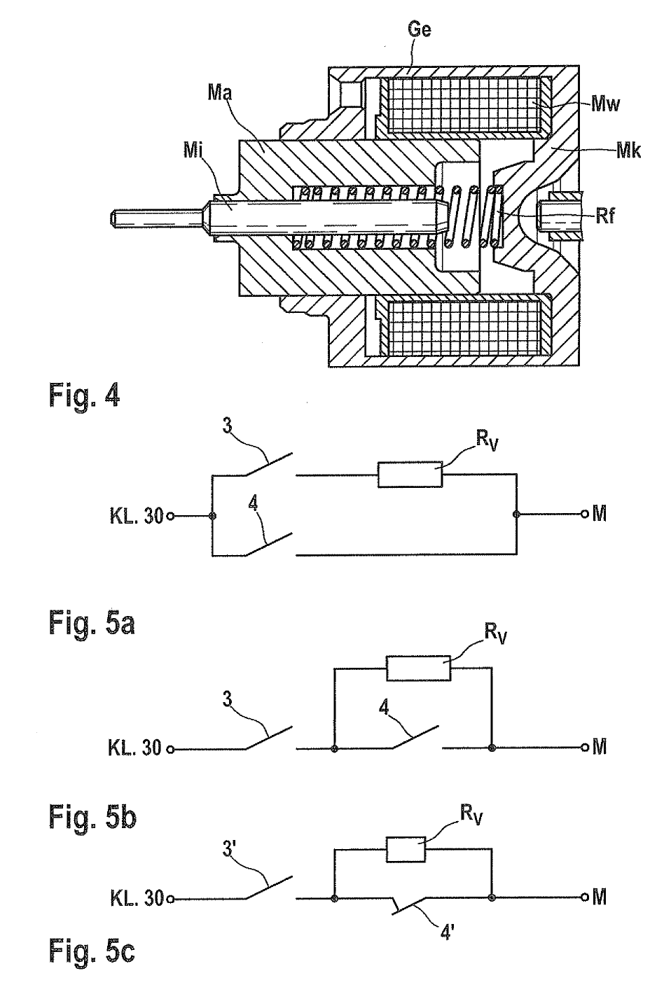

One exemplary embodiment of a mechanical relay is illustrated in FIG. 4. The mechanical relay shown in FIG. 4 has a magnetically conductive housing Ge, a magnet winding Mw, a magnet core Mk, a restoring spring Rf, an armature Ma, and a meshing drive Mi.

Switching module SM, which is provided for supplying the main starter current via a series resistor and also directly to the starter motor, has the two mechanical switches 3 and 4. Options for connecting same are illustrated in FIG. 5. According to FIG. 5a, a parallel connection is provided between terminal 30 of the motor vehicle and starter motor M, a series connection of first switch 3 and of series resistor R_{V} being situated in the first branch of this parallel connection, and second switch 4 being situated in the other branch of this parallel connection. This arrangement corresponds to the circuitry shown in FIG. 2. According to FIG. 5b, a series connection of two components is provided between terminal 30 of the motor vehicle and starter motor M. The first of these components is first switch 3. The second of these components is a parallel connection of series resistor R_{V} to second switch 4. According to FIG. 5c, a series connection of two components is provided between terminal 30 of the motor vehicle and starter motor M. The first of these components is a first switch 3′ which is acted upon by the main current relay. The second of these components is a parallel connection of series resistor R_{V} to a break contact 4′ which is acted upon by the starting current relay. When switch 3′ is closed, terminal 30 is connected to starter motor M via series resistor R_{V}. In the quiescent state, break contact 4′ short circuits series resistor R_{V}.

Switching module SM may be implemented as an add-on to the drive bearing of the device, or alternatively, as a stand-alone approach. For simplified requirements with regard to a dip in starting voltage, first switch 3 and series resistor R_{V} may optionally be dispensed with.

Series resistor R_{V} is preferably made of resistance material and implemented by an electrical line or a coil. It is important that heat dissipation is ensured due to the flowing currents of up to 800 A. Series resistor R_{V} may be integrated into a component, for example switching module SM or the drive bearing of starter motor M, or may be implemented as a stand-alone approach.

As previously explained in conjunction with FIG. 3, meshing module EM and switching module SM or solenoid switch ES, starting current relay KA, and main current relay KH, may be energized either directly by the engine control unit of the motor vehicle or by using a separate control unit of the motor vehicle. Another option is to use a separate driver unit.

For energizing meshing module EM and switching module SM, drivers for the relays as well as a logic system are used to ensure the desired functions of the overall device. These functions include rapid restarting of the internal combustion engine when a restart intent of the driver is present, which is initiated by depressing the gas pedal or the clutch or releasing the brake. These functions include in particular rapid restarting when the internal combustion engine is coasting. Additional functions are a reduction in a dip in starting voltage, as well as safety functions such as recognition of malfunctions and misuse situations, and shut-down in the event of error or in misuse situations.

Meshing relay ES is optionally energized in a current-controlled manner.

In addition, according to one advantageous specific embodiment of the present invention, the voltage applied to terminal 45 of the starter of the motor vehicle is read into control unit 5, and is taken into account by the control unit in energizing meshing module EM and switching module SM, in particular for determining the switching times of switching module SM and/or of meshing module EM. This allows a diagnosis as to whether or not the starter motor has cranked in the case of a current feed, and whether or not the meshing operation has occurred. This corresponds to an error diagnosis. Furthermore, it is thus possible to compensate for the variances in switching on and switching off of the switches, and to determine the run-up characteristic of the starter.

As stated above, the number of control lines between control unit 5 and the starter, including switching module SM, meshing module EM, and starter motor M, depends on the type of relays used.

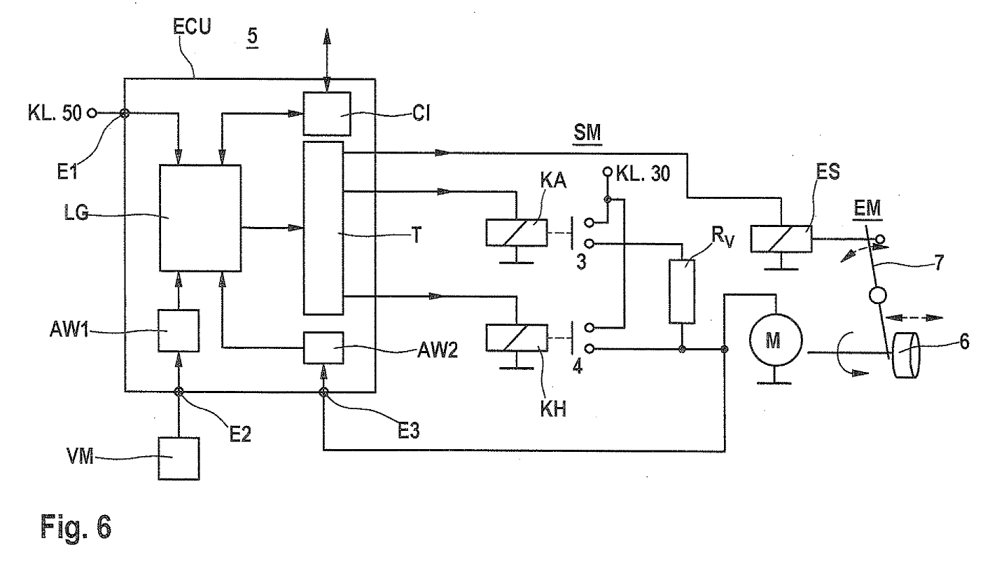

FIG. 6 shows a block diagram of a device for starting an internal combustion engine, in which solenoid switch ES, starting current relay KA, and main current relay KH are energized directly by engine control unit ECU of the motor vehicle.

Engine control unit ECU is connected to terminal 50 of the motor vehicle, and receives start information via this terminal at an input E1. In addition, engine control unit ECU contains a logic system LG for implementing the particular desired functions of the overall device. Furthermore, engine control unit ECU contains an input E2 for a sensor signal which is deduced from an engine speed sensor VM, and an evaluation unit AW1 which ascertains rotational speed n and angular position Φ of the crankshaft of internal combustion engine VM based on these sensor signals. The information concerning rotational speed n and angular position Φ is relayed to logic system LG, which uses this information for implementing the particular desired functions of the overall device. In addition, according to one advantageous embodiment, engine control unit ECU has an input E3 for a voltage signal which is deduced from terminal 45 of the motor vehicle, and an evaluation unit AW2 for evaluating this voltage signal.

The information concerning the measured voltage is likewise supplied to logic system LG, which uses this information for implementing the particular desired functions of the overall device. Furthermore, engine control unit ECU has a CAN interface CI, and is thus able to exchange data via the CAN bus with other modules of the motor vehicle. Lastly, a driver unit T is also integrated into engine control unit ECU. This driver unit T includes a total of three drivers which provide control signals for solenoid switch ES, starting current relay KA, and main current relay KH. The number of drivers varies depending on the number of relays and windings used, between two (ES: single winding, KH: single winding, KA: not applicable) to six (ES, KH, and KA each having a double winding) or nine (ES, KH, and KA energized, e.g., according to published German patent application document DE 10 2009 000 125.5).

The right portion of the device shown in FIG. 6 is the same as the right portion of the device shown in FIG. 2, except for the derivation of the voltage at terminal 45 of the motor vehicle.

The specific embodiment shown in FIG. 6 has the advantage that the separation of meshing and current switching allows the speeds of the starter and of the engine to be synchronized before the pinion meshes with the annular gear. The electromechanical elements allow cost-effective implementation. In addition, limiting the starting current of the starter results in less load on the vehicle electrical system, less mechanical stress, and acoustic improvements. Integrating the control into the engine control unit or another existing control unit makes use of available resources, and therefore represents a cost-effective approach.

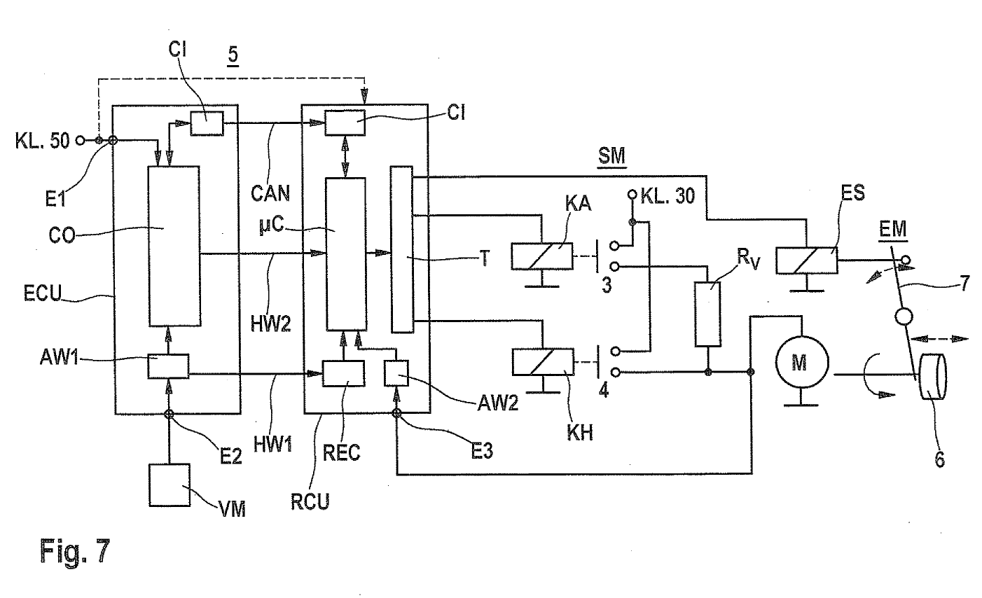

FIG. 7 shows a block diagram of a device for starting an internal combustion engine, in which solenoid switch ES, starting current relay KA, and main current relay KH are energized by a separate control unit RCU, which in turn is controlled by engine control unit ECU of the motor vehicle.

In this specific embodiment, the desired start-stop operation strategy is stored in engine control unit ECU, which then communicates with separate control unit RCU via a CAN bus CAN. In addition, a separate hardware line HW1 is provided between engine control unit ECU and separate control unit RCU, via which engine control unit ECU supplies separate control unit RCU with information concerning rotational speed n of the drive shaft of starter motor M. Furthermore, according to one advantageous embodiment, another separate line HW2 is provided between engine control unit ECU and separate control unit RCU, via which an emergency shutoff signal may be transmitted, if needed, from engine control unit ECU to control unit RCU which deactivates the start function if a malfunction is present. In addition, control unit RCU has a microcomputer μC for controlling the functions of the overall device in the desired manner.

As is apparent from FIG. 7, engine control unit ECU is connected to terminal 50 of the motor vehicle, and receives start information via this terminal and its input E1. It is also apparent from FIG. 7 that engine control unit ECU has an input E2 for a sensor signal which is deduced from an engine speed sensor VM, and an evaluation unit AW1 which ascertains rotational speed n and angular position Φ of the crankshaft of internal combustion engine (VM) based on these sensor signals. This information concerning rotational speed n and angular position Φ is transmitted to separate control unit RCU via previously mentioned separate line HW1. Furthermore, engine control unit ECU has a coordinator CO whose function, among other things, is to provide an emergency shutoff signal in the event of a malfunction, which is supplied to control unit RCU. In addition, engine control unit ECU contains a CAN interface CI to allow communication with control unit RCU via the CAN bus of the particular motor vehicle.

Control unit RCU likewise contains a CAN interface CI, and a unit REC for receiving the information concerning rotational speed n and angular position Φ of the crankshaft of internal combustion engine (VM). The signals received by control unit RCU via the CAN interface, an optionally received start signal which is deduced from terminal 50 of the motor vehicle, and the mentioned information concerning rotational speed n and the angular position of the crankshaft of internal combustion engine (VM) are supplied to microcomputer μC of control unit RCU, and are used by same for implementing the particular desired functions of the overall device. In addition, according to one advantageous embodiment, control unit RCU has an input E3 for a voltage signal which is deduced from terminal 45 of the motor vehicle, and an evaluation unit AW2 for evaluating this voltage signal. The information concerning the measured voltage is likewise supplied to microcomputer μC, and is used by same for implementing the desired functions of the overall device.

Furthermore, as is apparent from FIG. 7, a driver unit T is integrated into control unit RCU. This driver unit T includes a total of three drivers which provide control signals for solenoid switch ES, starting current relay KA, and main current relay KH. These control signals are provided directly to the mentioned relays. The number of drivers varies depending on the number of relays and windings used, between two (ES: single winding, KH: single winding, KA: not applicable) to six (ES, KH, and KA each having a double winding) or nine (ES, KH, and KA energized according to published German patent application document DE 10 2009 000 125.5).

The right portion of the device shown in FIG. 7 is the same as the right portion of the device shown in FIG. 2, except for the conduction of the voltage at terminal 45 of the motor vehicle.

The specific embodiment shown in FIG. 7 has the advantage that, compared to FIG. 6, only a slight modification in the hardware present in the engine control unit is necessary, so that the specific embodiment may be easily integrated into existing vehicle systems.

Alternatively, separate control unit RCU may be controlled by a different control unit having a microcontroller.

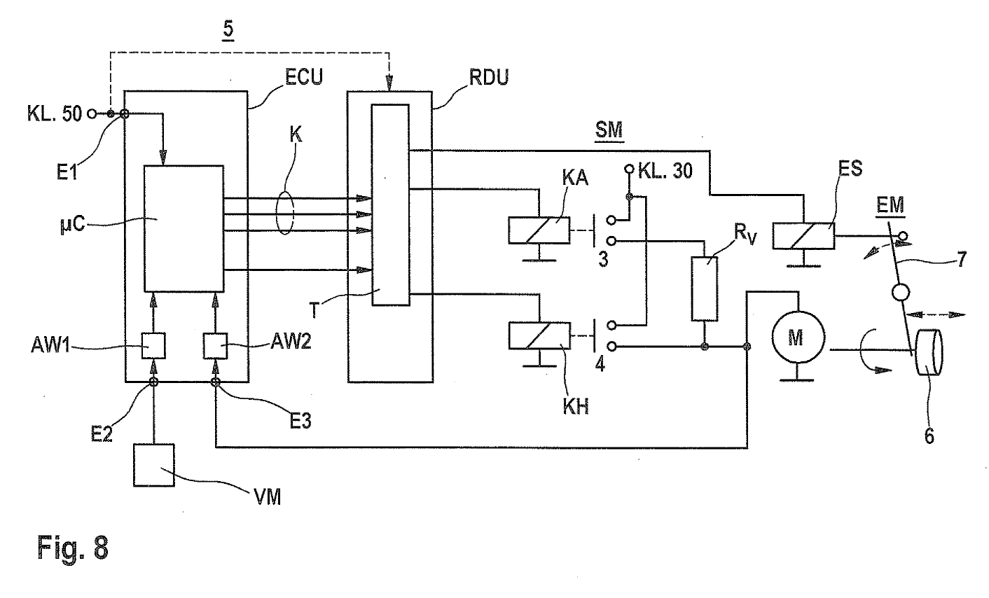

FIG. 8 shows a block diagram of a device for starting an internal combustion engine, in which solenoid switch ES, starting current relay KA, and main current relay KH are energized using a separate driver unit RDU. According to this variant, all start-stop functions, which include the start-stop coordination and the desired functions of the overall device, are implemented in engine control unit ECU as software. Via a communication or hardware interface K, engine control unit ECU controls mentioned separate driver unit RDU, which in turn energizes solenoid switch ES, starting current relay KA, and main current relay KH. The number of lines for interface K depends on the number of windings of relays ES, KA, and KH, the design of the driver unit, and the communication interface used. The number of drivers and control lines (between RDU and the relays) varies depending on the number of relays and windings used, between two (ES: single winding, KH: single winding, KA: not applicable) to six (ES, KH, and KA each having a double winding) or nine (ES, KH, and KA energized, e.g., according to published German patent application document DE 10 2009 000 125.5).

It is apparent from FIG. 8 that in this specific embodiment, engine control unit ECU is connected to terminal 50 of the motor vehicle, and receives start information via same. It is also apparent from FIG. 8 that this start information is relayed to a microcomputer μC of the engine control unit. In addition, an evaluation unit AW1 supplies the microcomputer with information concerning rotational speed n and angular position Φ of the crankshaft of internal combustion engine (VM). Evaluation unit AW1 receives sensor signals which are provided by an engine speed sensor VM.

In addition, according to one advantageous embodiment, engine control unit ECU has an evaluation unit AW2 for evaluating a voltage signal. This voltage signal is deduced from terminal 45 of the motor vehicle.

Microcomputer pC evaluates the signals supplied to it, and controls driver T of driver unit RDU via communication interface K.

In turn, the driver provides output signals for solenoid switch ES, starting current relay KA, and main current relay KH.

The microcomputer coordinates relays ES, KA, and KH via driver unit RDU in such a way that the particular desired functions of the overall device are carried out. If necessary, the microcomputer also supplies driver T with an emergency shutoff signal via a separate line HW2, thus terminating a start operation.

According to an alternative specific embodiment not illustrated in FIG. 8, driver unit RDU may also have an interface via which it communicates with engine control unit ECU. This interface is preferably composed of a maximum of two signal lines. This interface is a CAN bus interface, a LIN bus interface, or a FlexRay bus interface, for example. Furthermore, driver unit RDU may also have an input for a voltage signal which is deduced from terminal 45 of the motor vehicle, an evaluation unit for evaluating this voltage signal, and a further signal output for transmitting information concerning the evaluated voltage signal of terminal 45 to the engine control unit.

Alternatively, driver unit RDU may be controlled by a different control unit having a microcontroller instead of by the engine control unit.

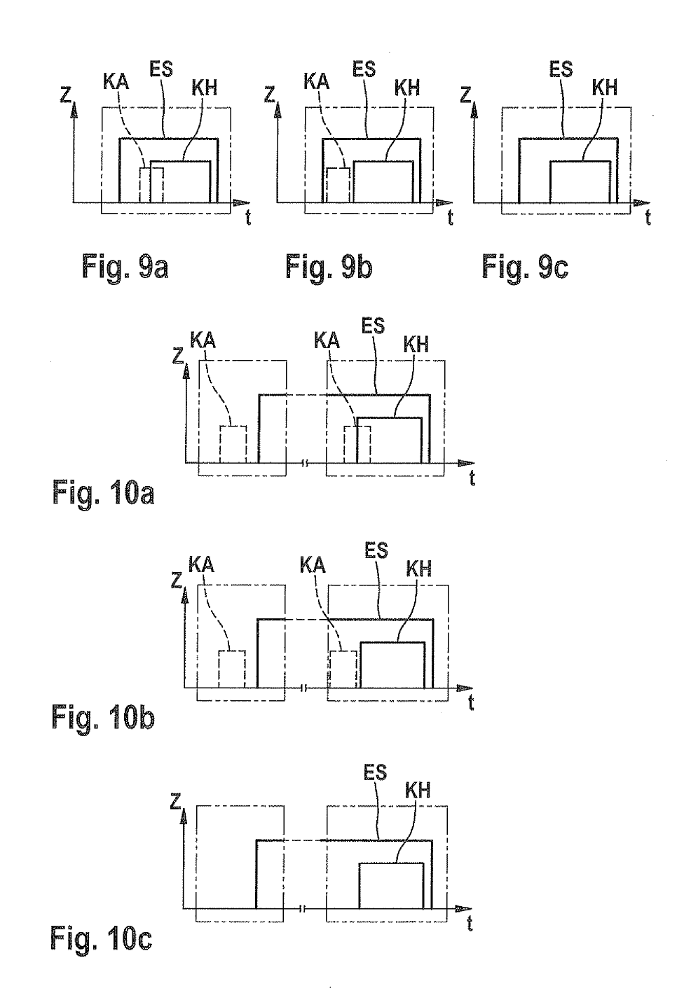

Examples of the energization sequence of relays ES, KA, and KH are described below with reference to FIGS. 9 and 10, FIG. 9 illustrating examples of an initial start of the vehicle which is initiated with the aid of a vehicle key, and FIG. 10 illustrating examples of an automatic start carried out within the scope of the start-stop operation. In each case, state Z of the particular relay (“off” or “on”) is plotted along the ordinate, and time t is plotted along the abscissa.

FIG. 9a illustrates a first exemplary embodiment of an initial start of the vehicle. In this first exemplary embodiment, solenoid switch ES is initially switched on in order to mesh the drive pinion with the annular gear on the crankshaft of the internal combustion engine. At a time thereafter, with solenoid switch ES still switched on, starting current relay KA is switched on in order to smoothly set starter motor M in motion via series resistor R_{V}. Once again at a time thereafter, with starting current relay KA and also solenoid switch ES still switched on, main current relay KH is switched on in order to drive the annular gear, and therefore the crankshaft, with the full force of starter motor M. Subsequently, starting current relay KA is switched off first, then main current relay KH is switched off, and lastly, solenoid switch ES is switched off.

FIG. 9b illustrates a second exemplary embodiment of an initial start of the vehicle. In this second exemplary embodiment, solenoid switch ES is initially switched on in order to mesh the drive pinion with the annular gear on the crankshaft of the internal combustion engine. At a time thereafter, with the solenoid switch still switched on, starting current relay KA is switched on in order to smoothly set starter motor M in motion via series resistor R_{V}. Once again at a time thereafter, with solenoid switch ES still switched on, but with starting current relay KA already switched off, main current relay KH is switched on in order to drive the annular gear, and therefore the crankshaft, with the full force of starter motor M. Subsequently, main current relay KH is switched off first, and then solenoid switch ES is switched off.

FIG. 9c illustrates a third exemplary embodiment of an initial start of the vehicle. In this third exemplary embodiment, solenoid switch ES is initially switched on in order to mesh the drive pinion with the annular gear on the crankshaft of the internal combustion engine. At a time thereafter, with solenoid switch ES still switched on, main current relay KH is switched on in order to use the starter motor right away with full force for driving the annular gear and therefore the crankshaft of the internal combustion engine. At a time thereafter, main current relay KH is initially switched off, and then solenoid switch ES is switched off. Starting current relay KA is inoperative in this third exemplary embodiment. Depending on the ambient temperature and/or the state of the vehicle electrical system, this third exemplary embodiment may be used when insufficient power is available via series resistor R_{V} for accelerating starter motor M in the initial or cold start.

FIG. 10a illustrates a first exemplary embodiment of an automatic start carried out within the scope of the start-stop operation. In this first exemplary embodiment, within the scope of a stopping operation the drive pinion initially meshes with the annular gear while the engine is still coasting. Starting current relay KA is switched on first in order to smoothly set starter motor M in motion. Subsequently, starting current relay KA is switched off. At a time thereafter, solenoid switch ES is switched on in order to mesh the drive pinion with the annular gear. At a time thereafter, with solenoid switch ES still switched on, the automatic start is carried out, which is initiated, for example, by depressing the gas pedal or by depressing the clutch pedal. Within the scope of this automatic start, starting current relay KA is initially switched on again in order to smoothly set starter motor M in motion. At a time thereafter, main current relay KH is switched on, with starting current relay KA still switched on. Subsequently, starting current relay KA is initially switched off, then main current relay KH is switched off, and lastly, solenoid switch ES is switched off.

FIG. 10b illustrates a second exemplary embodiment of an automatic start carried out within the scope of the start-stop operation. In this second exemplary embodiment, within the scope of a stopping operation the drive pinion initially meshes with the annular gear while the engine is still coasting. Starting current relay KA is switched on first in order to smoothly set starter motor M in motion. Subsequently, starting current relay KA is switched off. At a time thereafter, solenoid switch ES is switched on in order to mesh the drive pinion with the annular gear. At a time thereafter, with solenoid switch ES still switched on, the automatic start is carried out, which is initiated, for example, by depressing the gas pedal or by depressing the clutch pedal. Within the scope of this automatic start, the starting current relay KA is initially switched on again in order to smoothly set starter motor M in motion. Starting current relay KA is subsequently switched off again, with solenoid switch ES still switched on. At a time thereafter, main current relay KH is switched on in order to drive starter motor M with full force. Subsequently, main current relay KH is switched off, and lastly, solenoid switch ES is switched off.

FIG. 10c illustrates a third exemplary embodiment of an automatic start carried out within the scope of the start-stop operation. In this third exemplary embodiment, within the scope of a stopping operation the drive pinion initially meshes with the annular gear while the engine is still coasting. Solenoid switch ES is switched on in order to mesh the drive pinion with the annular gear. At a time thereafter, with solenoid switch ES still switched on, the automatic start is carried out, which is initiated, for example, by depressing the gas pedal or by depressing the clutch pedal. Within the scope of this automatic start, with solenoid switch ES still switched on, main current relay KH is switched on in order to drive starter motor M with full force. At a time thereafter, main current relay KH is switched off, and then solenoid switch ES is switched off. In this third exemplary embodiment, the drive pinion meshes while the engine is coasting, without prior cranking of starter motor M via the starting current relay and series resistor R_{V}.

In the exemplary embodiments described in FIG. 10, after the meshing operation has been carried out while the engine is coasting, a predefined time interval advantageously commences, and after the time interval elapses, solenoid switch ES is disengaged without an automatic start or restart so that the vehicle electrical system is not subjected to load from the holding current of the solenoid switch over an extended period of time. In this type of approach, for a restart, solenoid switch ES must initially be reactivated before the starting current may be switched to starter motor M via starting current relay KA, and before the main current may be switched to starter motor M via main current relay KH.

Optionally, the exemplary embodiments described in FIG. 10 may be implemented without the meshing operation while the engine is coasting. In this case, the meshing operation must take place immediately before the starter is energized via KH or KA.

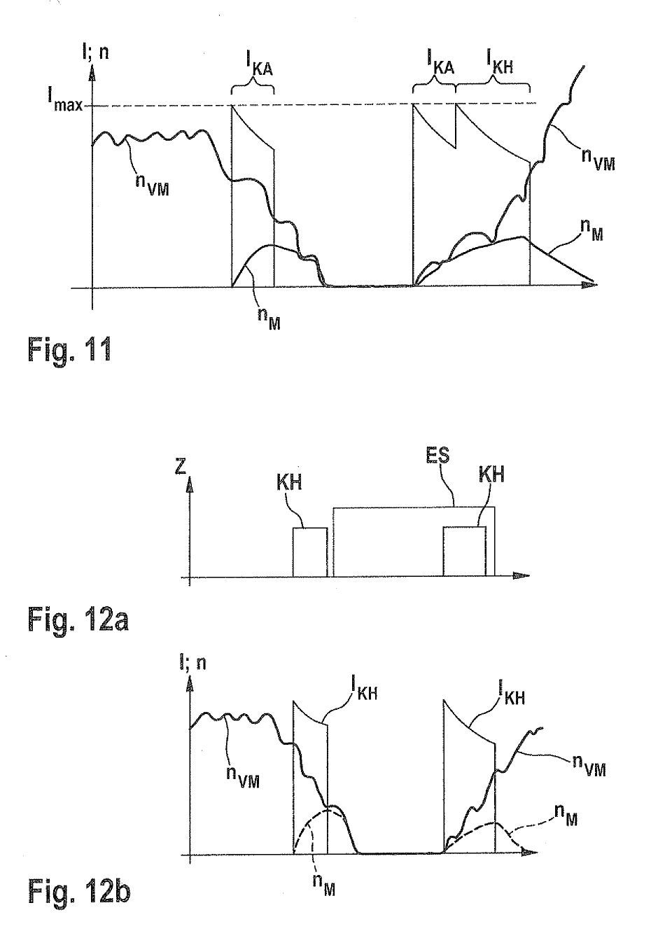

FIG. 11 shows a diagram for illustrating one example of the variation over time of engine speed n_{VM} of the internal combustion engine, rotational speed n_{M} of starter motor M, and current I_{KA} and I_{KH} during a start-stop operation.

FIGS. 12a and 12b illustrate one example of a simplified system in which starting current relay KA and series resistor R_{V} are not provided, and the starting is carried out using main current relay KH.

In the examples described above with reference to FIGS. 6 and 7, it was stated that control unit 5 has a CAN bus interface CI in order to be able to communicate with other components via a CAN bus. Alternatively, control unit 5 may have a LIN bus interface or a FlexRay bus interface in order to be able to communicate with other components via a LIN bus or a FlexRay bus.

As described above or as an alternative thereto, the control unit may carry out the sequence of energizing the relays as follows:

Control unit 5 energizes meshing module EM and switching module SM in such a way that meshing module EM is energized in a first step, and switching module SM is subsequently energized in a second step. Solenoid switch ES of meshing module EM is preferably energized in the first step, and starting current relay KA and main current relay KH of switching module SM are subsequently energized in the second step, starting current relay KA being initially energized, and main current relay KH being subsequently energized.

Alternatively, control unit 5 energizes meshing module EM and switching module SM in such a way that solenoid switch ES of meshing module EM is energized in a first step, and main current relay KH of switching module SM is subsequently energized in a second step.

Another alternative is for control unit 5 to energize meshing module EM and switching module SM in such a way that switching module SM is energized in a first step, and meshing module EM is subsequently energized in a second step.

A further alternative is for control unit 5 to energize meshing module EM and switching module SM in such a way that starting current relay KA of switching module SM is energized in a first step, and solenoid switch ES of meshing module EM is subsequently energized in a second step.

A further alternative is for control unit 5 to energize meshing module EM and switching module SM in such a way that main current relay KH of switching module SM is energized in a first step, and solenoid switch ES of meshing module EM is subsequently energized in a second step.

1-31. (canceled)

32. A device for starting an internal combustion engine, comprising:
a meshing module for meshing a drive pinion;
a starter motor;
a switching module via which a starter current is supplied to the starter motor, wherein the switching module has one of (i) a main current relay, or (ii) a combination of a starting current relay and a main current relay; and
a control unit for energizing the meshing module and the switching module.

33. The device as recited in claim 32, wherein the meshing module has one of a solenoid switch or an electric servomotor.

34. The device as recited in claim 33, wherein the solenoid switch acts on the drive pinion via an engaging shift lever.

35. The device as recited in claim 33, wherein the starter motor is connected to a terminal of a motor vehicle via the switching module.

36. The device as recited in claim 35, wherein the starting current relay acts on a first switch, and wherein the terminal is connected to the starter motor via a series resistor when the first switch is closed.

37. The device as recited in claim 35, wherein the main current relay acts on a second switch, and wherein the terminal is connected to the starter motor when the second switch is closed.

38. The device as recited in claim 36, wherein the main current relay acts on a second switch, and wherein the terminal is connected to the starter motor when the second switch is closed and when the first switch is closed.

39. The device as recited in claim 35, wherein:
the main current relay acts on a first switch;
the terminal is connected to the starter motor via a series resistor;
the starting current relay acts on a break contact; and
the break contact in the quiescent state short-circuits the series resistor when the first switch is closed.

40. The device as recited in claim 35, wherein the control unit is an engine control unit of the motor vehicle, and wherein the engine control unit includes:
a first input for start information;
a second input for a sensor signal from an engine speed sensor;
a first evaluation unit which ascertains a rotational speed and an angular position of a crankshaft of the internal combustion engine based on corresponding sensor signals;
a logic system; and
a driver unit controlled by the logic system, wherein the driver unit provides control signals for the meshing module and the switching module.

41. The device as recited in claim 40, wherein the control unit further includes:
a third input for a voltage signal from the terminal of the motor vehicle; and
a second evaluation unit for evaluating the voltage signal from the terminal of the motor vehicle.

42. The device as recited in claim 35, wherein the control unit is a separate control unit from an engine control unit, and wherein the engine control unit controls the separate control unit.

43. The device as recited in claim 42, wherein the engine control unit includes:
a first input for start information;
a second input for a sensor signal from an engine speed sensor;
a first evaluation unit which ascertains a rotational speed and an angular position of a crankshaft of the internal combustion engine based on corresponding sensor signals;
a bus interface; and
a coordinator which provides an emergency shutoff signal for the separate control unit when a malfunction is present.

44. The device as recited in claim 43, wherein the separate control unit includes:
a bus interface via which the separate control unit communicates with the engine control unit;
a microcomputer;
a receiver unit for receiving information regarding a rotational speed and an angle of a crankshaft of the internal combustion engine; and
a driver unit controlled by the microcomputer, the driver unit providing control signals for the meshing module and the switching module.

45. The device as recited in claim 44, wherein the separate control unit further includes:
a third input for a voltage signal from the terminal of the motor vehicle; and
a second evaluation unit for evaluating the voltage signal.

46. The device as recited in claim 42, wherein the separate control unit and the engine control unit have one of a CAN, LIN, or FlexRay bus interface.

47. The device as recited in claim 35, wherein the control unit has a separate driver unit which is controlled by an engine control unit.

48. The device as recited in claim 47, wherein the engine control unit includes:
a first input for start information;
a second input for a sensor signal from an engine speed sensor;
a first evaluation unit which ascertains a rotational speed and an angular position of a crankshaft of the internal combustion engine based on corresponding sensor signals; and
a microcomputer which provides control signals for the separate driver unit.

49. The device as recited in claim 48, wherein the engine control unit further includes:
a third input for a voltage signal from the terminal of the motor vehicle; and
a second evaluation unit evaluating the voltage signal.

50. The device as recited in claim 35, wherein the control unit energizes the meshing module and the switching module in such a way that the meshing module is energized in a first step and the switching module is subsequently energized in a second step.

51. The device as recited in claim 50, wherein the control unit energizes the meshing module and the switching module in such a way that:
(i) in a first step, the solenoid switch of the meshing module is energized in a first step; and
(ii) in a second step following the first step, the starting current relay is energized and subsequently the main current relay of the switching module is energized.

52. The device as recited in claim 50, wherein the control unit energizes the meshing module and the switching module in such a way that the solenoid switch of the meshing module is energized in a first step, and the main current relay of the switching module is subsequently energized in a second step.

53. The device as recited in claim 48, wherein the control unit energizes the meshing module and the switching module in such a way that the switching module is energized in a first step, and the meshing module is subsequently energized in a second step.

54. The device as recited in claim 53, wherein the control unit energizes the meshing module and the switching module in such a way that the starting current relay of the switching module is energized in a first step, and the solenoid switch of the meshing module is subsequently energized in a second step.

55. The device as recited in claim 48, wherein the control unit energizes the meshing module and the switching module in such a way that the main current relay of the switching module is energized in a first step, and the solenoid switch of the meshing module is subsequently energized in a second step.

56. The device as recited in claim 50, wherein the control unit takes into account the voltage from the terminal of the motor vehicle in controlling the meshing module and the switching module.

57. The device as recited in claim 56, wherein the control unit uses the voltage from the terminal of the motor vehicle for an error diagnosis.

58. The device as recited in claim 57, wherein the control unit uses the voltage from the terminal of the motor vehicle for determining at least one of a switching time of the switching module and a switching time of the meshing module.

59. The device as recited in claim 56, wherein the control unit uses the voltage from the terminal of the motor vehicle for adapting at least one of (i) a switching time of the switching module as a function of at least one of an operating state and an operating time of the switching module, and (ii) a switching time of the meshing module as a function of at least one of an operating state and an operating time of the meshing module.

60. The device as recited in claim 56, wherein the control unit uses the voltage from the terminal of motor vehicle for compensating for at least one of (i) variations in switching times of the switching module, and (ii) variation in switching times of the meshing module.

61. The device as recited in claim 56, wherein the control unit uses the voltage from the terminal of the motor vehicle for determining a run-up characteristic of the device.
